(19) United States
(12) Patent Application Publication
(10) Pub. No.: US 2023/0351482 A1
(43) Pub. Date: Nov. 2, 2023

(54) SHOPPING LIST SERVICE

(71) Applicant: NCR Corporation, Atlanta, GA (US)

(72) Inventors: Gina Torcivia Bennett, Lawrenceville, GA (US); Kip Oliver Morgan, Atlanta, GA (US)

(21) Appl. No.: 17/733,481

(22) Filed: Apr. 29, 2022

(51) Int. Cl. G06Q 30/06; G06Q 30/02

(52) U.S. Cl. CPC G06Q 30/0641; G06Q 30/0633; G06Q 30/0206; G06Q 30/0613

(57) ABSTRACT

An interface is rendered on a user-operated device. A shopping list of items defined by a user is obtained through the interface. A store associated with the items is identified and a tax jurisdiction for the store. Each item of the list is checked in inventory at the store, a set of substitute items are identified for each item, and available promotions are identified for each item and each substitute item. A total price for the list of the items that includes taxes in the jurisdiction of the store and includes any promotion pricing is provided to the user through the interface. The user can interact with the list through the interface to evaluate scenarios where the original list and/or a modified list meets a budget defined by the user or select an automatically determined list that identifies a lowest priced substitute for each item until the budget is met.

### BACKGROUND

With the constantly increasing prices of every day items occurring due to unrestrained inflation, it is becoming more difficult for the typical consumer to afford their basic necessities. From toilet paper to milk, consumers are becoming more budget conscious in order to be able to buy the needs of their day-to-day lives. Often lower-price substitutes that offer similar quality at a lower price exist, however, the consumer does not know of these substitute items.

A budget conscious consumer often creates a shopping list for a particular store; sometimes, by using a third-party service, such as Freshop®. The individual base prices of any given item are known, and can be added up for an estimated total, however, this is not the actual price paid at the store by the consumer. Calculating promotion pricing, when promotions are available, requires specialized processing that is typically not available in the third-party services used by the consumers. The same is true with tax calculations on the items of the shopping list.

In fact, each state or county within a state has its own tax rate and tax rules. Some jurisdictions tax edible items and not inedible items; some tax all items; some only tax certain items, such as tobacco, alcohol, etc. Some consumers may live in an area that spans two or three different jurisdictions, such that only a few miles results in different tax rates and tax rules from where a given consumer lives or works.

Additionally, because of the supply-chain issues being experienced post-pandemic, inventory levels are spotty at best, which means that items a consumer desires have a good chance of being out of stock by the time the consumer goes to a store to fulfill their shopping list.

These issues are particularly problematic for consumers on strict budgets that they want to adhere to so that they can purchase other desired things, pay down existing debt, take a vacation, and/or save more.

### SUMMARY

In various embodiments, methods and a system for providing a shopping list service are presented.

According to an aspect, a method for providing a shopping list service, is presented. A list of items and a budget price associated with a user are received and a store for the list of items is identified. A taxing jurisdiction for a geographical location of the store is identified and any promotions associated with any of the items at the store are obtained. In-store prices for each of the items are obtained. An actual total price for the list of items is calculated using the in-store prices, any promotion discounted price available for any of the items, and tax rates and tax rules associated with the taxing jurisdiction. The actual total price is provided to the user.

### BRIEF DESCRIPTION OF THE DRAWINGS

FIG. 1 is a diagram of a system for providing a shopping list service, according to an example embodiment.

FIG. 2 is a diagram of a method for providing a shopping list service, according to an example embodiment.

FIG. 3 is a diagram of another method for providing a shopping list service, according to an example embodiment.

### DETAILED DESCRIPTION

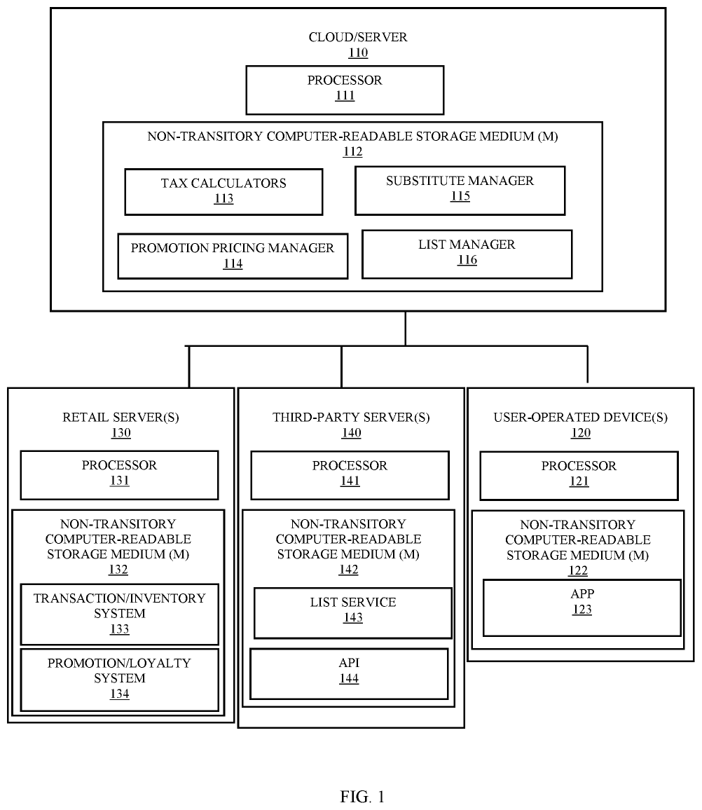

FIG. 1 is a diagram of a system 100 providing a shopping list service, according to an example embodiment. It is to be noted that the components are shown schematically in greatly simplified form, with only those components relevant to understanding of the embodiments being illustrated.

Furthermore, the various components (that are identified in FIG. 1) are illustrated and the arrangement of the components is presented for purposes of illustration only. It is to be noted that other arrangements with more or less components are possible without departing from the teachings of providing a shopping list service as presented herein and below.

As will be discussed in the various embodiments that follow, the teachings provide techniques by which a user can use a shopping list via a mobile application (app) and a customer facing interface of the app to accurate calculate the actual cost of a shopping list, identify substitute items for shopping items that are out of stock, and allow the user to interactively try substitute items for items that may be in stock to see what cost savings may be achieved. A user may also set a budget and compare a current list's total cost against the budget, when the budget is exceeded by the calculated costs, the user can select an option within the user-facing interface of the app to allow automated substitution of items for any of the items in the list and allow the shopping service to find a combination of existing items in the list and substitute items that will meet the budgeted cost of the user.

As used herein, the terms “consumer,” “customer,” “user,” and/or “shopper” may be used interchangeably and synonymously herein and below. This refers to an individual that has a shopping list and a budget and wants to discover a scenario for the list that will meet the budget.

System 100 comprises a cloud/server 110, a plurality of customer-operated devices 120, one or more retail servers 130, and a plurality of in-store transaction terminals 140.

Cloud/Server 110 comprises at least one processor 111 and a non-transitory computer-readable storage medium 112. Medium 112 comprises executable instructions for one or more tax calculators 113, a pricing promotion manager 114, a substitute manager 115, and a list manager 116. The executable instructions when executed by processor 111 from the medium 112 cause processor 111 to perform operations discussed herein and below with respect to 113-116.

Each customer-operated device 120 comprises a processor 121 and a non-transitory computer-readable storage medium 122. Medium 122 comprises executable instructions for a mobile app 123. The executable instructions when executed by processor 121 from medium 122 cause processor 121 to perform operations discussed herein and below with respect to app 123.

Each retail server 130 comprises a processor 131 and a non-transitory computer-readable storage medium 132. Medium 132 comprises executable instructions for a transaction/inventory system 133 and a promotion/loyalty system 134. The executable instructions when executed by processor 131 from medium 132 cause processor 131 to perform operations discussed herein and below with respect to 133 and 134.

Each third-party server 140 comprises a processor 141 and a non-transitory computer-readable storage medium 142. Medium 142 comprises executable instructions for a list service 143 and an Application Programming Interface (API) 144. The executable instructions when executed by processor 141 from medium 142 cause processor 141 to perform operations discussed herein and below with respect to 143 and 144.

App 123 can be an existing third-party app associated with an existing list service 143 of an existing retailer-specific list service offered by a specific retailer. The existing app is enhanced as app 123 to interact with cloud/server 110 in the manners discussed herein and below. The enhancement includes new options to the user-facing interface of the existing app and an API to interact with cloud/server 110 when the new options are selected and interacted with by the user operating device 120.

In an embodiment, app 123 is a newly provided app 123 and is not an enhanced version of an existing app.

It should be noted that app 123 may also be web-based and rendered through web pages rather that a device-specific app 123 (although app 123 can also be a device-specific app 123). In fact, app 123 may be both accessible via device 120 as a standalone app 120 and also accessible via a web browser.

Initially, the user operates the user-facing interface of app 123 to create a shopping list of items. Before entering the shopping list or after entering the shopping list, the user-facing interface provides a budget total option from which the user can select and enter a total amount to be evaluated for the list of items. The user either before creating the list and the budget total or after, selects a specific store that the user will be using for the list of items. The list of items, the budget total, and a store identifier for the selected store are sent via an API from a backend of app 123 to list manager 116.

List manager 116 uses the store identifier to identify the proper tax calculator for the jurisdiction of the store selected by the user. The list manager 116 passes the list of items and the store identifier to promotion pricing manager 114. Manager 114 uses the store identifier identify a retailer associated with the store and uses an API to query the corresponding promotion/loyalty system 134 associated with that store identifier and each item of the list. Every available promotion for each item of the list is identified and associated with the corresponding items of the list.

List manager 116 also passes the list and the store identifier to substitution manager 115. Manager 115 uses the store identifier and an API to interact with the corresponding retailer's inventory system 133 and identifies whether each item on the list is available in inventory at the selected store. For each item that is unavailable or available in inventory, manager 115 obtains one or a set of known substitute items for the corresponding unavailable item.

Next, substitution manager 115 may provide the list of substitute items per item (available or unavailable) back to promotion pricing manager 114. Manager 114 searches promotion/loyalty system for any promotion that is available per substitute item for each set.

List manager 116 then receives a data structure for each item of the list that identifies whether the corresponding item is available in inventory, identifies each available substitute item, identifies any promotion per corresponding item of the list, and per each of the substitute items associated with the corresponding item.

Next, list manager 116 uses an API to obtain the current in-store price of each item of the list, each substitute item, and each substitute item after applying a given promotion. This pricing information is updated within the data structure for each item of the list.

At this point, list manager 116 is ready to calculate an actual price of the originally submitted list of items from the user via the app 123 using the list and the data structure associated with each item in the list.

Assuming all items of the list were in inventory and had no promotions associated with them, manager 116 obtains the current item price per item and the tax calculator for the jurisdiction associated with the selected store and calculates a total price for the list of items including tax. This total price is then compared against the user-supplied budgeted price. If the total calculated price is less than the user-supplied budget price, manager 116 sends and itemized item price for each item, the tax amount, and the total actual price to the backend of app 123, which presents the corresponding pricing details to the user through the user-facing interface.

When the actual calculated total is over the budget price, the itemized and total price is sent to the backend of app 123 for viewing through the user-facing interface by the user along with additional user-interface options that allows the user to view substitute items and their pricing and promotions and how this affects the budget total. Since manager 116 retains the data structures that is associated with each item, as the user selects items to see substitute items and selects a substitute item, manager 116 can instantly adjust the actual total to show the user whether or not the budget price was met with the change. The user can select substitutes with promotions and the promotion pricing is applied by manager 116 and the current total for the list is updated accordingly within the user-facing interface of app 123 for the user to view.

When one or more items are not available in inventory (out of stock) at the selected store, the manager 116 attempts to select a replacement substitute item that will get the total cost closer to the budget of the user as possible. For example, selecting from the data structure associated with the out-of-stock item, a given substitute item with the lowest cost or one with a lowest cost following application of an available promotion. The list is returned with the selected substitute item along with a user-facing interface option to change the substitute item. The user can interactively view all substitute items for the out-of-stock item and override the manager 116 supplied substitute item. Manager 116 uses the data structure to automatically update the total price and itemized pricing based on the user override.

Because manager 116 has a list of initially supplied items for a given store and a data structure off of each item that identifies that item's promotions available, substitute items, and promotions available per substitute item, along with the pricing of all scenarios. The user can iteratively interact with manager 116 through the user-facing interface of app 123 to play out different scenarios until the budget for the items is met.

The user may also elect to let the manager 116 find a scenario of substitute items and available promotions that will meet the budget price. Manager 116 iterates the list and the data structures to find the scenarios where the budget can be met and returns each scenario as an option for the user to either select or modify.

This iterative cycle can be repeated as many times as is desired by the user through the user-facing interface of app 123 interacting with manager 116.

In an embodiment, each item in an original list of items includes an option for the user to select through the user-facing interface of app 123 to directly engage manager 116 with the item selected. Manager 116 asks substitute manager 115 to determine if the item is in stock and generate the list of available substitute items for the item whether it is in stock or not. The list of available substitute items and the item are passed to promotion pricing manager 114 and manager 114 engages promotion system 134 to obtain any available promotions associated with the item and each of the substitute items. Manager 116 interacts with transaction system 133 and obtains the current in-store price for the item, price with any available promotion, and price with or without any available promotions for the substitute items. This information is saved in a data structure for the selected user item. The user can then view the in-store price of the item, promotion price after applying a promotion, and each of the available substitute items and their in-store prices with or without any available promotions. Optionally, manager 116 may engage the corresponding tax manager 113 to present the prices for the item and the scenarios as an after-tax price or this may be an option for the user to select within the user-facing interface of app 123.

In an embodiment, the user can override the list of available substitute items for any given item that is in stock or out of stock and enter their own item in place of that item on the list. This engages manager 116 to engage managers 115, 114, and the corresponding tax calculator 113 to generate a total price for that item after any promotion is applied and to update the current actual total and true price of the list of items after the user manually overrides a particular item with a user-determined item.

In an embodiment, app 123 provides a user-identifier or a user-loyalty number for the user to manager 116, this is used by promotion pricing manager 114 to obtain loyalty member pricing with the items on the list even before any available promotion price is determined for an available promotion.

In an embodiment, manager 116 determines that a given user is not a loyalty member of a selected store and displays within the user-facing interface of app 123 the difference in each item's price and the total true price for the list to the user versus the loyalty member price. In an embodiment, manager 116 uses an API to interact with a given user and register the user with a given retailer's loyalty system 134.

In an embodiment, manager 116 lets the user through the user-facing interface select multiple stores and performs the analysis discussed above for each store, such that the user can determine the lowest price store for the list of items.

In an embodiment, manager 116 obtains the list of the user through a third-party list service 143 which is linked to the user of all 123 or which the user identifies through a user identifier associated with the list service 143 and which the user provides through the user-facing interface of app 123.

It is noted that a variety of different features are possible to the user through user-facing interface of app 123 via cloud/server 110 based on obtaining in-store inventory, in-store pricing, in-store substitute items, and in-store available loyalty and/or promotion pricing. Thus, all such features that can be supported by this real-time acquired information and by applying a jurisdiction-based tax calculator 113 for a chosen store are intended to be included in the embodiments presented herein.

One now appreciates, how an interactive app 123 associated with cloud/server 110 can provide interactive and iterative actual true pricing to a budget conscious user for a given shopping list at a given store within a given known tax jurisdiction. Any user chosen scenario with the list can be simulated, manager 116 can auto-determine a set of items (substitute and/or user provided) that meet or are below a budget set price by the user.

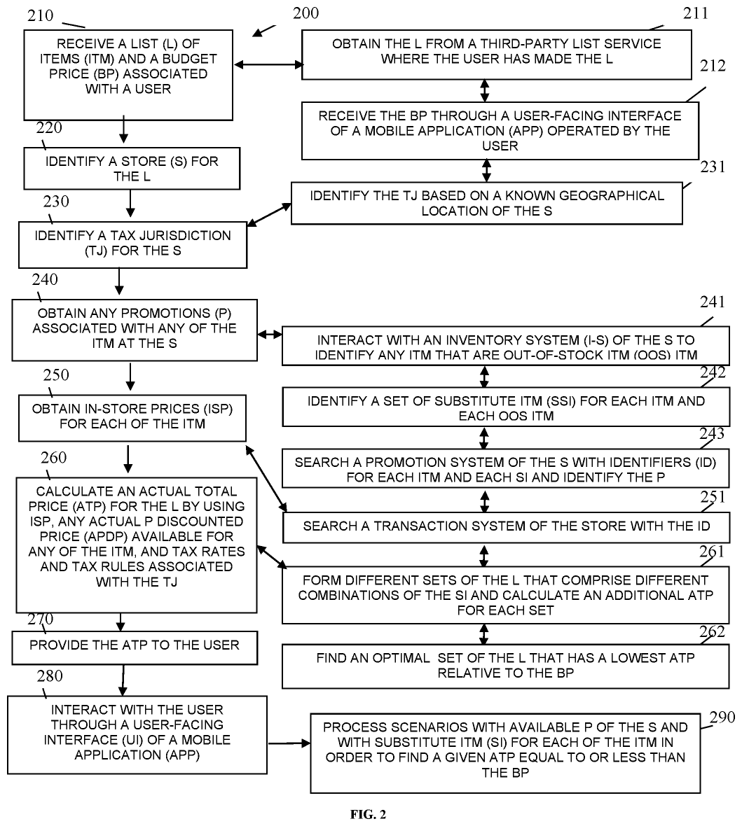

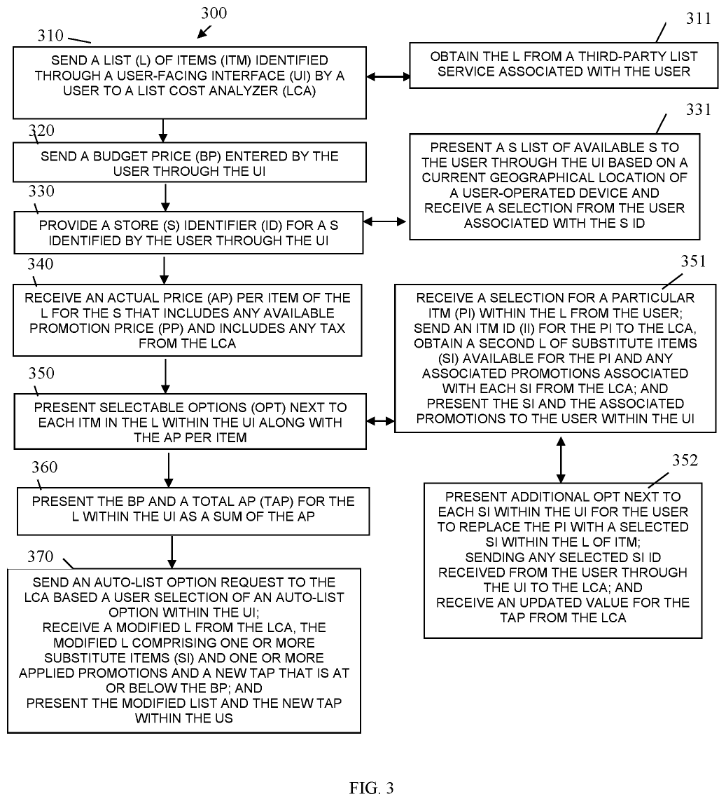

The above-referenced embodiments and other embodiments are now discussed with reference to FIGS. 2-3.

FIG. 2 is a diagram of a method 200 for providing a shopping list service, according to an example embodiment. The software module(s) that implements the method 200 is referred to as a “shopping list cost analyzer.” The shopping list cost analyzer is implemented as executable instructions programmed and residing within memory and/or a non-transitory computer-readable (processor-readable) storage medium and executed by one or more processors of one or more devices. The processor(s) of the device(s) that executes the shopping list cost analyzer are specifically configured and programmed to process the shopping list cost analyzer. The shopping list cost analyzer has access to one or more network connections during its processing. The connections can be wired, wireless, or a combination of wired and wireless.

In an embodiment, the device that executes the shopping list cost analyzer is cloud 110. In an embodiment, the device that executes is server 110.

In an embodiment, the device that executes the shopping list cost analyzer is retail server 130.

In an embodiment, the device that executes the shopping list cost analyzer is server 140 associated with a third-party list service 143.

In an embodiment, the shopping list cost analyzer is all of, or some combination of model(s) 113, 114, 115, and/or 116.

In an embodiment, 113-116 is processed as a cloud-based Software-as-a-Service (SaaS) to the app 123.

At 210, shopping list cost analyzer receives a list of items and a budget price associated with a user.

In an embodiment, at 211, the shopping list cost analyzer obtains the list from a third-party list service 143 where the user has made and stored the list.

In an embodiment of 221 and at 222, the shopping list cost analyzer receives the budget price through a user-facing interface of a mobile application 123 operated by the user.

At 220, the shopping list cost analyzer identifies a store for the list of items.

At 230, the shopping list cost analyzer identifies a tax jurisdiction from the store.

In an embodiment of 212 and 230, at 231, the shopping list cost analyzer identifies the tax jurisdiction based on a known geographical location of the store.

At 240, the shopping list cost analyzer obtains any promotions associated with any of the items available at the store.

In an embodiment, at 241, the shopping list cost analyzer interacts with an inventory system 133 of the store to identify any items that are out-of-stock items at the store.

In an embodiment of 241 and at 242, the shopping list cost analyzer identifies a set of substitute items for each item and for each out-of-stock item.

In an embodiment of 242 and at 243, the shopping list cost analyzer searches a promotion system 134 of the store with identifiers from each item and each of the substitute items and identifies the promotions.

At 250, the shopping list cost analyzer obtains in-store prices for each of the items.

In an embodiment of 243 and 250, at 251, the shopping list cost analyzer searches a transaction system 133 of the store with the identifiers to obtain the in-store prices for each item of the list and each substitute item.

At 260, the shopping list cost analyzer calculates an actual total price for the list of items by using the in-store prices, any actual promotion discounted price available for any of the items, and tax rates and tax rules associated with the tax jurisdiction of the store.

In an embodiment of 251 and 260, at 261, the shopping list cost analyzer forms different sets of the list of items that comprise different combinations of the substitute items and calculates an additional actual total price for each set of the lists.

In an embodiment of 261 and at 262, the shopping list cost analyzer finds an optimal set of the lists that has the lowest actual total price relative to the budget price.

At 270, the shopping list cost analyzer provides the actual total price to the user.

In an embodiment, at 280, the shopping list cost analyzer interacts with the user through a user-facing interface of a mobile application 123.

In an embodiment of 280, at 290, the shopping list cost analyzer processes scenarios with available promotions of the store and with substitute items for each of the items in order to find a given actual total price equal to or less than the budget price.

FIG. 3 is a diagram of another method 300 for providing a shopping list service, according to an example embodiment. The software module(s) that implements the method 300 is referred to as a “shopping list app.” The shopping list app is implemented as executable instructions programmed and residing within memory and/or a non-transitory computer-readable (processor-readable) storage medium and executed by one or more processors of one or more devices. The processor(s) of the device(s) that executes the shopping list app are specifically configured and programmed to process the shopping list app. The shopping list app has access to one or more network connections during its processing. The network connections can be wired, wireless, or a combination of wired and wireless.

In an embodiment, the device that executes the shopping list app is user-operated device 120. In an embodiment, the device 120 is a phone, a laptop, a watch, a tablet, or glasses.

In an embodiment, cloud 110 hosts shopping list app via a web-browser processing on user-operated device 120.

In an embodiment, the shopping list app is app 123.

The shopping list app interacts with list manager 115 and/or method 200.

At 310, the shopping list app sends a list of items identified through a user-facing interface by a user to a list cost analyzer 116 and/or method 200.

In an embodiment, at 311, the shopping list app obtains the list from a third-party list service 143 associated with the user.

At 320, the shopping list app sends a budget price entered by the user through the user-facing interface.

At 330, the shopping list app provides a store identifier for a store identified by the user through the user-facing interface.

In an embodiment, at 331, the shopping list app presents a list of available stores to the user through the user-facing interface based on a current geographical location of a user-operated device 120 and the shopping list app receives a selection from the user associated with the store identifier.

At 340, the shopping list app receives an actual price per item of the list for the store that includes any available promotions and includes any tax associated with the store from the list cost analyzer 116 and/or method 200.

At 350, the shopping list app presents selectable options next to each item in the list within the user-facing interface along with the actual price per item.

In an embodiment, at 351, the shopping list app receives a selection for a particular item within the list from the user. The shopping list app sends an item identifier for the particular item to the list cost analyzer 116 and/or method 200. The shopping list app obtains a second list of substitute items available for the particular item and any associated promotions associated with each substitute item from the list cost analyzer 116 and/or method 200. The shopping list app presents the substitute items and the associated promotions to the user within the user-facing interface.

In an embodiment of 351 and at 352, the shopping list app presents an additional option next to each substitute item within the user-facing interface for the user to replace the particular item with a selected substitute item within the list of items. The shopping list app sends any selected substitute item received from the user through the user-facing interface to the list cost analyzer 116 and/or method 200. The shopping list app receives an updated value for a total actual price from the list cost analyzer 116 and/or method 200.

At 360, the shopping list app presents the budget price and a total actual price for the list of items within the user-facing interface as a sum of the individual actual prices for the items of the list.

In an embodiment, at 370, the shopping list app sends an auto-list option request to the list cost analyzer 116 and/or method 200 based on a user selection of an auto-list option within the user-facing interface. The shopping list app receives a modified list of items from the list cost analyzer 116 and/or method 200. The modified list of items comprising one or more substituted items and one or more applied promotions and new total actual price that is at or below the budget price. The shopping list app presents the modified list of items and the new total actual price within the user-facing interface to the user.

It should be appreciated that where software is described in a particular form (such as a component or module) this is merely to aid understanding and is not intended to limit how software that implements those functions may be architected or structured. For example, modules are illustrated as separate modules, but may be implemented as homogenous code, as individual components, some, but not all of these modules may be combined, or the functions may be implemented in software structured in any other convenient manner.

Furthermore, although the software modules are illustrated as executing on one piece of hardware, the software may be distributed over multiple processors or in any other convenient manner.

The above description is illustrative, and not restrictive. Many other embodiments will be apparent to those of skill in the art upon reviewing the above description. The scope of embodiments should therefore be determined with reference to the appended claims, along with the full scope of equivalents to which such claims are entitled.

In the foregoing description of the embodiments, various features are grouped together in a single embodiment for the purpose of streamlining the disclosure. This method of disclosure is not to be interpreted as reflecting that the claimed embodiments have more features than are expressly recited in each claim. Rather, as the following claims reflect, inventive subject matter lies in less than all features of a single disclosed embodiment. Thus, the following claims are hereby incorporated into the Description of the Embodiments, with each claim standing on its own as a separate exemplary embodiment.

1. A method, comprising:
receiving a list of items and a budget price associated with a user;
identifying a store for the list of items;
identifying a taxing jurisdiction for the store;
obtaining any promotions associated with any of the items at the store;
obtaining in-store prices for each of the items;
calculating an actual total price for the list of items by using the in-store prices, any promotion discounted price available for any of the items, and tax rates and tax rules associated with the taxing jurisdiction; and
providing the actual total price to the user.

2. The method of claim 1 further comprising:
interacting with the user through a user-facing interface of a mobile application.

3. The method of claim 2 further comprising:
processing scenarios with available promotions of the store and with substitute items for each of the items in order to obtain and to make the actual total price be equal to or less than the budget price.

4. The method of claim 1, wherein receiving further includes obtaining the list for the user from a third-party list service where the user has made the list.

5. The method of claim 4, wherein receiving further includes receiving the budget price through a user-facing interface of a mobile application operated by the user.

6. The method of claim 5, wherein identifying the tax jurisdiction further includes identifying the tax jurisdiction based on a known geographical location of the store.

7. The method of claim 1, wherein obtaining any promotions further includes interacting with an inventory system of the store to identify any items that are out-of-stock at the store.

8. The method of claim 7, wherein interacting further includes identifying a set of substitute items for each item and each out-of-stock item from the inventory system.

9. The method of claim 8, wherein identifying the sets further includes searching a promotion system of the store with identifiers for each item and each substitute item and identifying the promotions.

10. The method of claim 9, wherein obtaining the in-store prices further includes searching a transaction system of the store with the identifiers.

11. The method of claim 10, wherein calculating further includes forming different sets of the list that comprise different combinations of the substitute items and calculating an additional actual total price for each set.

12. The method of claim 11, wherein forming further includes finding an optimal set of the list that has the lowest actual total price relative to the budget price.

13. A method, comprising:
sending a list of items identified through a user-facing interface by a user to a list cost analyzer;
sending a budget price entered by the user through the user-facing interface;
providing a store identifier for a store identified by the user through the user-facing interface;
receiving an actual price per item of the list for the store that includes any available promotion price and includes any tax from the list cost analyzer;
presenting selectable options next to each item in the list within the user-facing interface along with the actual price per item; and
presenting the budget price and a total actual price for the list within the user-facing interface as a sum of the actual prices.

14. The method of claim 13 further comprising:
sending an auto-list option request to the list cost analyzer based on a user selection of an auto-list option within the user-facing interface;
receiving a modified list of items from the list cost analyzer, wherein the modified list of items comprising one or more substituted items and one or more applied promotions and a new total actual price that is at or below the budget price; and
presenting the modified list of items and the new total actual price within the user-facing interface.

15. The method of claim 13, wherein sending the list further includes obtaining the list from a third-party list service associated with the user.

16. The method of claim 13, wherein providing further includes presenting a store list of available stores to the user through the user-facing interface based on a current geographical location of a user-operated device and receiving a selection from the user associated with the store identifier.

17. The method of claim 13, wherein presenting the selectable options further includes receiving a selection for a particular item within the list from the user, sending an item identifier for the particular item to the list cost analyzer, obtaining a second list of substitute items available for the particular item and any associated promotions associated with each substitute item from the list cost analyzer, and presenting the substitute items and the associated promotions to the user within the user-facing interface.

18. The method of claim 17 further comprising:
presenting additional selectable options next to each substitute item within the user-facing interface for the user to replace the particular item with a selected substitute item within the list of items;
sending any selected substitute item identifier received from the user through the user-facing interface to the list cost analyzer; and
receiving an updated value for total actual price from the list cost analyzer.

19. A system, comprising:
a server comprising a processor and a non-transitory computer-readable storage medium;
the non-transitory computer-readable storage medium comprises executable instructions; and
the executable instructions when executed by the processor from the non-transitory computer-readable storage medium cause the processor to perform operations, comprising:
receiving a list of items, a store identifier for a store, and a budget price from a user who is interacting with a user-facing interface of an application;
identifying a tax and tax rules for a geographical location associated with the store identifier;
determining whether any of the items are out-of-stock items at the store from an inventory system of the store;
assembling a set of substitute items for each item and each out-of-stock item;
identifying any promotions associated with each of the items and each of the substitute items from a promotion system of the store;
assigning an item price to each item and each substitute item by obtaining the corresponding item price from a transaction system of the store;
creating a data structure for each of the items in the list, each data structure comprising any of the promotions associated with the corresponding item, whether the corresponding item is in stock or out of stock, the corresponding set of substitute items, any of the promotions available for each of the corresponding substitute items, and the corresponding item price for the corresponding item and each of the corresponding substitute items of the corresponding set;
calculating an actual total price for the list of items using the corresponding item prices, the corresponding promotions, the tax rate, and the tax rules;
determining any difference between the actual total price and the budget price; and
interacting with the user through the user-facing interface of the application to identify a modified list of items with a corresponding actual total price that is at or below the budget price using the data structures.

20. The system of claim 19 further comprising processing the executable instructions as a cloud-based Software-as-a-Service to the mobile application.
